(19) United States
(12) Patent Application Publication
(10) Pub. No.: US 2012/0234397 A1
(43) Pub. Date: Sep. 20, 2012

(54) LIQUID SEPARATION SYSTEMS FOR INSTALLING IN LIQUID DISTRIBUTION SYSTEMS, AND COMPONENTS, KITS AND METHODS THEREFOR

(76) Inventor: Netzer Peled, Yuvalim (IL)

(21) Appl. No.: 13/512,110

(22) PCT Filed: Nov. 30, 2010
(86) PCT No.: PCT/IL2010/000996

§ 371 Date: May 25, 2012

Related U.S. Application Data
(60) Provisional application No. 61/283,190, filed on Dec. 1, 2009.

(51) Int. Cl. E03B 7/07; F16K 31/18

(52) U.S. Cl. 137/15.01; 137/561 R; 137/395; 137/551; 137/409

(57) ABSTRACT

Liquid separation systems for installing in liquid distribution installations having a conduit with a first liquid destination, a first liquid supply for supplying a first liquid into the conduit, and a second liquid supply for supplying a second liquid into the conduit via an accessible conduit access unit with an inlet and an outlet in flow communication with the conduit. The liquid separation systems are configured to redirect the second liquid to a second liquid destination different from the first liquid destination.

### FIELD OF THE INVENTION

The invention pertains to liquid separation systems for installing in liquid distribution installations.

### BACKGROUND OF THE INVENTION

Liquids originating from different sources are frequently discharged into a same conduit where they mix and flow to a same destination. Such is the case, for example, in some industrial facilities where liquid wastes from different processes are discharged into a same waste conduit and flow together to a same waste liquid collection point such as a collection tank, or alternatively to a discharge point leading to a larger liquid distribution system such as, for example, a municipal sewage distribution system. Another such example is found in sewage installations in single and multi-story residential, commercial, and industrial structures, where so-called black water, whose sources are typically toilets and kitchen sinks, are discharged into a sewage pipe into which so-called gray water from gray water sources such as wash basins, showers, tubs, and washing machines, are also discharged. The mixed black water and gray water then flow through the conduit to the same destination which may include, for example, the municipal sewage distribution system.

Environmental concerns arising from discharging different liquids into a same conduit leading to a same destination has placed pressure on government agencies to regulate this practice. For example, in many areas, government regulations now require that new constructions include separate conduits for each type of liquid, the conduits leading to separate destinations thereby preventing the different types of discharged liquids from mixing. Maintaining the liquids separated increases the feasibility of recycling/reusing some types of liquids as recycling costs are substantially reduced. Furthermore, use of the recycled liquid provides economic savings by reducing new consumption.

Despite the potential economic and environmental advantages of directing the different types of liquids to separate destinations, implementing this practice for existing constructions is relatively problematic due to the amount of work required and the high costs associated with performing such work. Generally, the work entails opening holes and channels in existing floors, walls, and/or ceilings, for installing new piping required to distribute the different liquids to the separate destinations. In many cases, the work further involves removal and replacement of surface finishing materials such as, for example, floor and wall tiles, or the redoing of surface finishes such as textured surfaces, painted surfaces, and the like, which contribute to substantially increasing the cost of refurbishing the existing installation compared to the cost of building a new installation in a new construction.

Liquid separation systems are known in the art. Liquid separation systems are illustrated and described in inter alia AU0076095A0, AU0208796A0, AU0250995A0, AU0635495A0, AU0798196A0, AU50800961A1, AU6202133AA, CA2122330AA, CA2592294AA, CA2626031AA, CA2695670AA, CN21103143Y, EP0632873A4, EP0732457A3, EP0855473A2, EP2014837A2, EP2186951A1, GB2331323B, GB2375761A1, GB2430444B2, GB2460632A, NZ0550740A, U.S. Pat. No. 4,588,325, U.S. Pat. No. 5,099,874, U.S. Pat. No. 5,147,532, U.S. Pat. No. 5,496,468, U.S. Pat. No. 6,702,942, US20090222981A1, US20090272447A1, and WO2007036685A1.

### SUMMARY OF THE INVENTION

The present invention is directed towards liquid separation systems for installing in liquid distribution installations having at least two liquid supplies discharging into a common conduit and transported to a common liquid destination wherein at least one of the liquid supplies discharges liquid into the common conduit via an accessible conduit access unit. The liquid separation systems are configured for directing liquid from at least one of the liquid supplies to a separate liquid destination from the common liquid destination. The liquid separation systems include a liquid separation assembly for installation in a conduit access unit to prevent second liquid flowing into the common conduit, and to redirect the second liquid flow through a piping system threaded through the conduit to a second liquid destination different from the common liquid destination. The liquid separation systems can be configured for installing in liquid distribution installations having a single conduit access unit or multiple conduit access units. In the latter instance, liquid separation systems may have a single common second liquid destination or multiple second liquid destinations.

In some preferred embodiments of the present invention, liquid separation systems are gravity based employing gravity to cause a second liquid to flow from its associated conduit access unit to a second liquid destination different from a common first liquid destination. Such gravity based liquid separation systems therefore take advantage of gradients in a liquid distribution installation.

In other preferred embodiments of the present invention, the liquid separation systems are automatic systems, and include a pump unit for drawing second liquid from its associated conduit access unit to a second liquid destination different from the common first liquid destination. Alternatively, the conduit access unit may be fitted with a pump unit for pumping the second In some embodiments, the pump unit includes a filter for filtering the second liquid when drawn into the pump, and may include a water inlet for priming the pump unit. The automatic liquid separation systems includes a controller for activating and deactivating the pump unit responsively to a sensing signal received from a liquid level sensing mechanism included in the liquid separation assembly. The controller may have a test feature for detecting system failures and for activating a visual warning indicator, for example, a lamp. The system may include a controller override for disconnecting the controller and allowing the pump to be manually activated or deactivated. In the case of a pump unit being fluidly connected to a plurality of liquid separation assemblies located at multiple locations throughout a liquid distribution installation, each liquid separation assembly includes a blocking mechanism for preventing air being drawn into the piping system and reaching the operating pump unit from any one of the locations due to low level of the second liquid at the location. The blocking mechanism may form part of the liquid level sensing mechanism, or may be an independent mechanism.

The liquid separation systems of the present invention are suitable for recycling and/or reusing dissimilar liquids which would otherwise be costly, or possibly unfeasible, to separate at a common liquid destination. Another potential advantage of the liquid separation system is disposing of dissimilar liquids directed to the different destinations may be easier and less costly than disposing of dissimilar liquids transported to the same liquid destination. And yet another potential advantage is the liquid separation system's particular suitability for retrofitting existing liquid distribution installations, maximizing a use of existing components such as common conduits and conduit access units. The liquid separation systems of the present invention are particularly suitable for separating grey water from black water at residential homes, apartment blocks, and the like.

The liquid separation systems of the present invention are suitable for installation in new and existing liquid distribution installations and particularly suitable for retrofitting existing liquid distribution systems. For exemplary purposes, the Detailed Description of Preferred Embodiments of the Invention hereinafter describe and illustrate using liquid separation systems with existing liquid distribution installations.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 shows a schematic diagram of an exemplary existing liquid distribution installation having a first liquid supply, a second liquid supply, and a common first liquid destination in fluid communication with the first and second liquid supplies through a same conduit;

FIG. 2 shows a schematic diagram of a gravity based liquid separation system retrofitted to FIG. 1's liquid distribution installation;

FIG. 3A is a front view of a first preferred embodiment of a liquid separation assembly for installation in a conduit access unit;

FIG. 3B is a side view of FIG. 3A's liquid separation assembly for installation in a conduit access unit;

FIG. 3C is a top view of FIG. 3A's liquid separation assembly installed in a conduit access unit;

FIG. 4A is a front view of a second preferred embodiment of a liquid separation assembly for installation in a conduit access unit;

FIG. 4B is a side view of FIG. 4A's liquid separation assembly for installation in a conduit access unit;

FIG. 4C is a top view of FIG. 4A's liquid separation assembly installed in a conduit access unit;

FIG. 5A is a front view of a third preferred embodiment of a liquid separation assembly for installation in a conduit access unit;

FIG. 5B is a side view of FIG. 5A's liquid separation assembly for installation in a conduit access unit;

FIG. 5C is a top view of FIG. 5A's liquid separation assembly installed in a conduit access unit;

FIG. 6 is a front view of a fourth preferred embodiment of a liquid separation assembly having an overflow port;

FIG. 7 is a front view of a fifth preferred embodiment of a liquid separation assembly having an overflow port;

FIG. 8 shows a schematic diagram of an automatic liquid separation retrofitted to a FIG. 1's liquid distribution installation;

FIG. 9 shows a liquid separation assembly with a port opening reducer for use in FIG. 8's liquid separation system;

FIG. 10 shows a schematic diagram of another embodiment of an automatic liquid separation system retrofitted to FIG. 1's liquid distribution installation and fluidly connecting multiple second liquid supplies to the second liquid destination through a same piping system in a same conduit;

FIG. 11 shows a schematic diagram of yet another embodiment of an automatic liquid separation system installed on a large liquid distribution network having several existing liquid distribution installations of FIG. 1, and fluidly connecting multiple second liquid supplies to the second liquid destination through separate piping systems in different conduits;

FIG. 12 is a flow diagram of a method of installing liquid separation systems according to some embodiments of the present invention; and

FIG. 13 shows a gravity-based liquid separation system kit, including options for upgrading the kit to an automatic liquid separation system kit, including for installations with multiple second liquid supplies.

### DETAILED DESCRIPTION OF PREFERRED EMBODIMENTS OF THE INVENTION

Liquid Distribution Installation

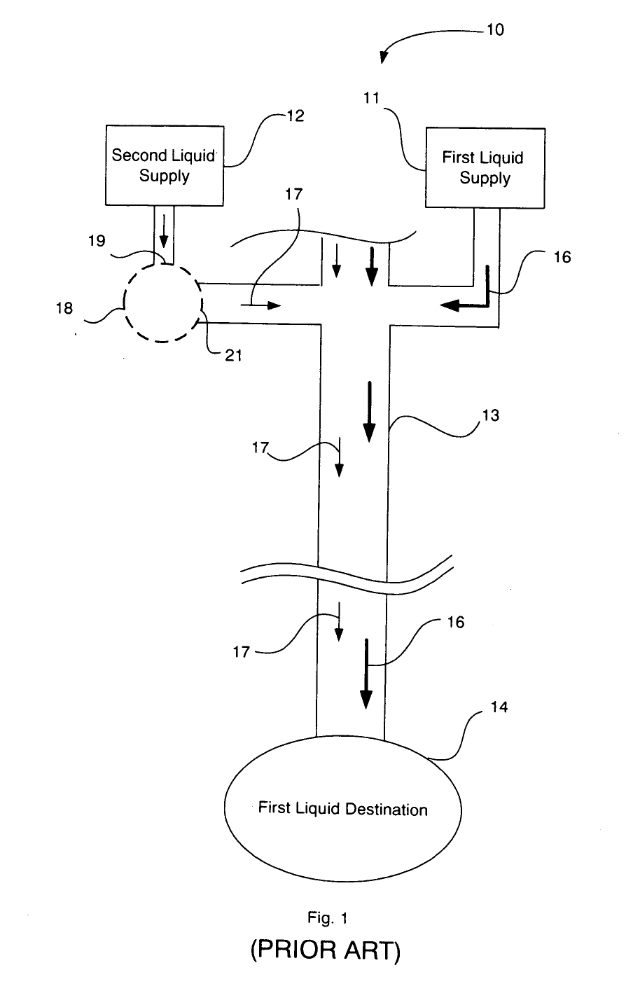

FIG. 1 shows an existing liquid distribution installation 10 having a first liquid supply 11 and a second liquid supply 12 in fluid communication with a conduit 13 leading to a common first liquid destination 14. A first liquid 16 from the first liquid supply 11 flows into the conduit 13 where it joins, possibly mixing, with a second liquid 17 flowing into the conduit 13 from the second liquid supply 12. The first liquid 16 and the second liquid 17 are dissimilar liquids, for example, two different waste chemicals, black water and gray water, or any other type of dissimilar liquids. The second liquid supply 12 connects to the conduit 13 through an accessible conduit access unit 18 having an inlet 19 and an outlet 21 through which the second liquid 17 flows in and out of the conduit access unit 18, respectively, to the conduit 13. The conduit access unit 18 may be installed so that it is easily accessible, for example installed in a floor or on the ground and having a cover which is removed to access its interior. Alternatively, the conduit access unit 18 may be installed under a protective cover or surface which requires removal in order to reach the conduit access unit 18.

Gravity Based Liquid Separation Systems

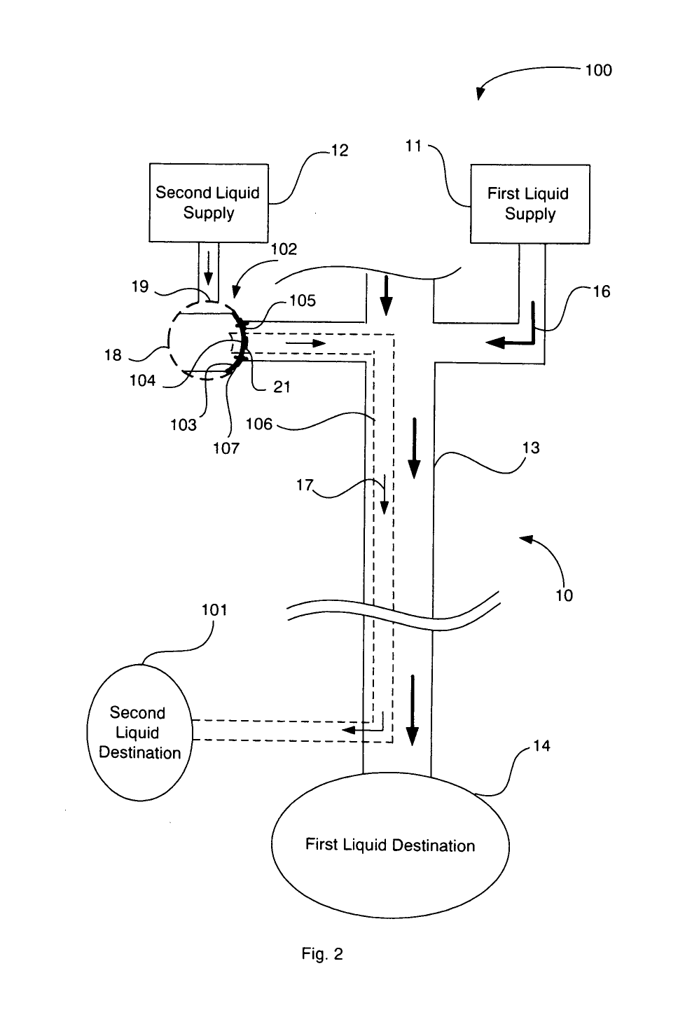

FIG. 2 shows an exemplary liquid separation system 100 for redirecting the second liquid 17 flowing from the second liquid supply 12 in the existing liquid distribution installation 10 to a second liquid destination 101 different from the first liquid destination 14. The liquid separation system 100 is a gravity-based system wherein second liquid 17 flow through the system 100 is effected by gravity.

The liquid separation system 100 includes a liquid separation assembly 102 which is fitted into the conduit access unit 18, and includes a liquid separation element 103 for preventing the second liquid 17 from flowing through the outlet 21 to the conduit 13. The liquid separation element 103 includes a liquid separation port 104 fluidly connected to a piping system 106 through which the second liquid 17 flows out of the conduit access unit 18 into the piping system 106. The piping system 106 is threaded through at least a section of the conduit 13 from the second liquid destination 101 to the liquid separation port 104, enabling second liquid 17 flow from the conduit access unit 18 to the second liquid destination 101. The liquid separation element 103 optionally includes an overflow port 107 for allowing the second liquid 17 to flow into the conduit 13 and therethrough to the first liquid destination 14 should the second liquid 17 reach a predetermined overflow level inside the conduit access unit 18.

Liquid Separation Assemblies 15

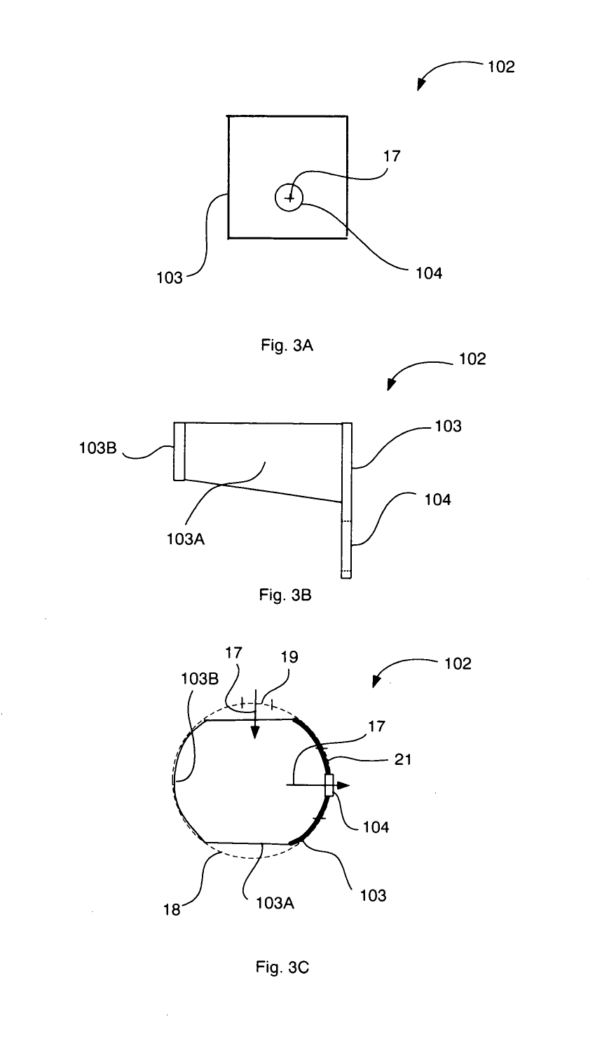

FIGS. 3A and 3B show a front view and a side view of the liquid separation assembly 102, respectively, and FIG. 3C shows a top view of the liquid separation assembly 102 inside the conduit access unit 18. The liquid separation assembly 102 includes the liquid separation element 103 and the liquid separation port 104. The liquid separation assembly 102 additionally includes side supports 103A and a back support 103B for fittedly supporting the liquid separation element 103 in place within the conduit access unit 18 partially, or wholly, covering the outlet 21. The side supports 103 are arranged so that they do not interfere with the second liquid 17 flowing into the conduit access unit 18 through the inlet 19. The liquid separation assembly 102 includes a flexible material and/or an elastic material for fitted insertion into the conduit access unit 18, and is resistant to contact with the second liquid 17. The materials may include plastic, a relatively high Shore rubber or other elastomeric material, metal, or any combination thereof. The liquid separation assembly 102 may be integrally formed, or may have any of its components (liquid separation element 103, side supports 103A, back support 103B, liquid separation port 104, and the overflow port 107) separately formed and joined together during production of the liquid separation assembly 102 or alternatively, prior to, or during, fitting into the conduit access unit 18.

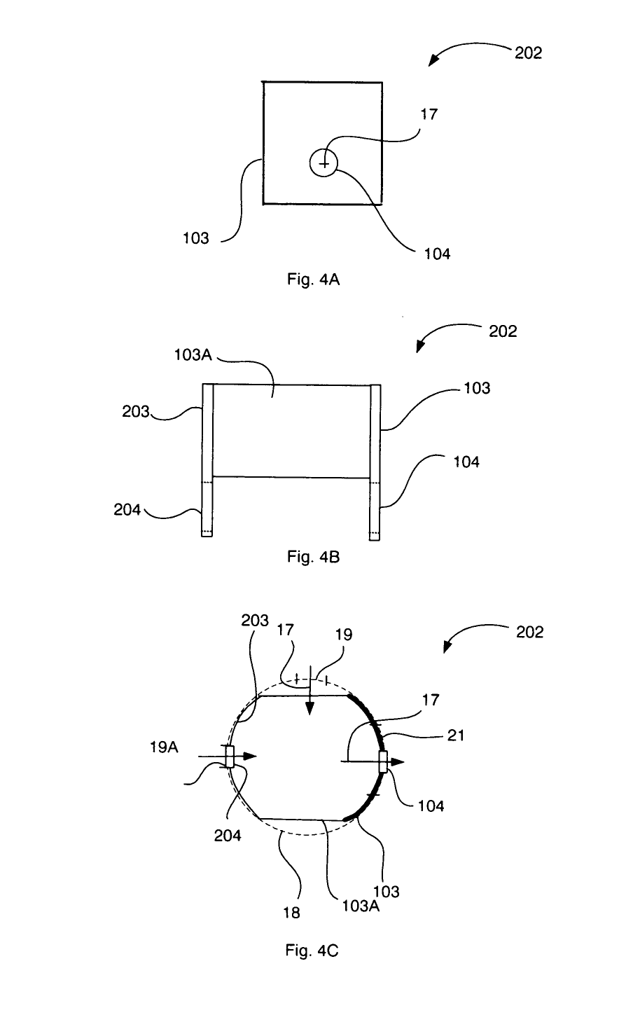

FIGS. 4A and 4B show a front view and a side view of a liquid separation assembly 202, respectively, and FIG. 4C shows a top view of the liquid separation assembly 202 inside the conduit access unit 18. The liquid separation assembly 202 is similar to the liquid separation assembly 102 shown in FIGS. 3A-3C, and includes the liquid separation element 103, the liquid separation port 104, and the side supports 103, and differs from the latter in that liquid separation assembly 202 includes a back support 203 configured with an inlet port 204 for enabling a second liquid 17 from a different second liquid supply (not shown) to flow into the conduit access unit 18 through a second inlet 19A.

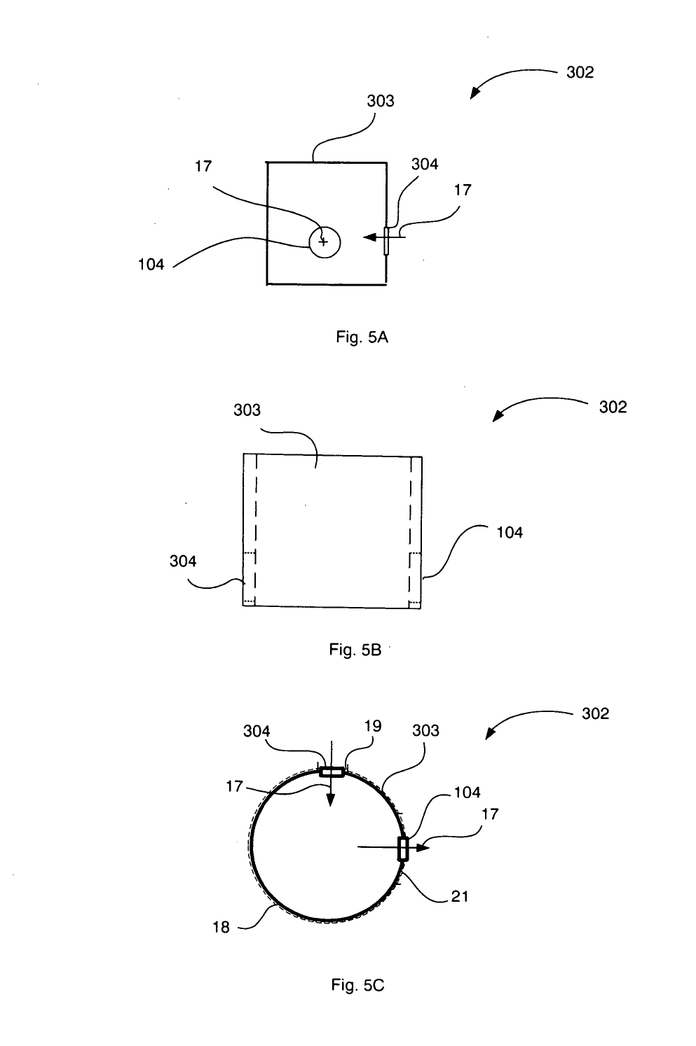

FIGS. 5A and 5B show a front view and a side view of a liquid separation assembly 302, respectively, and FIG. 5C shows a top view of the liquid separation assembly 302 inside the conduit access unit 18. The liquid separation assembly 302 includes a liquid separation element 303 functionally and materially similar to the liquid separation element 103 in FIGS. 3A-3C and includes the liquid separation port 104. The liquid separation element 303 is cylindrically shaped for fittedly supporting the liquid separation assembly 302 inside conduit access unit 18 and partially, or wholly, covers outlet 21 to prevent second liquid 17 flow through conduit 21. To prevent blocking the inlet 19 by the cylindrical shape of the liquid separation element 303, an inlet port 304 is included in the liquid separation element 303 which aligns with the inlet 19, enabling second liquid 17 flow into the conduit access unit 18.

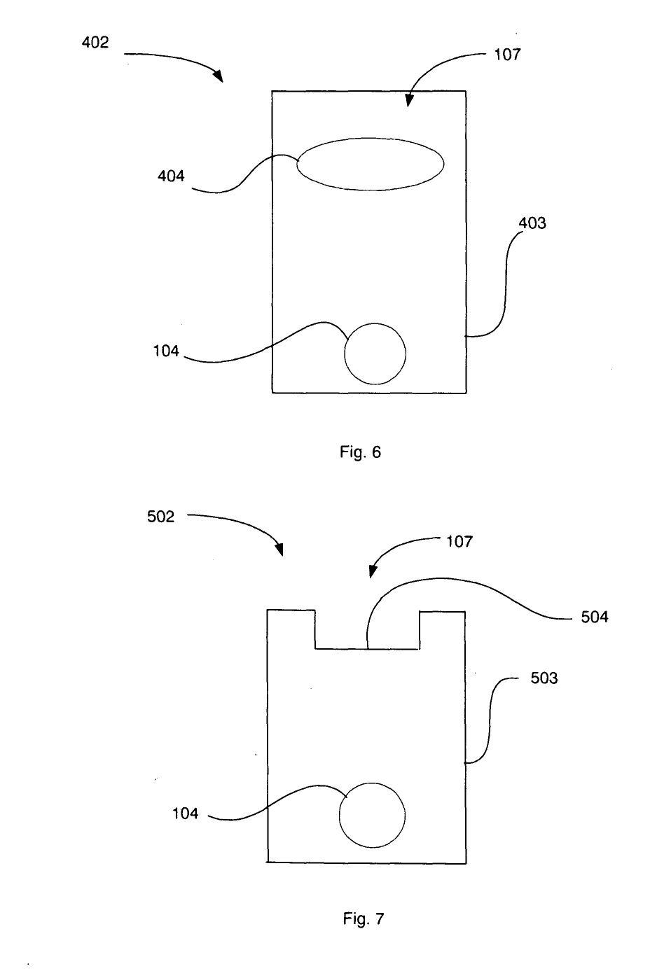

FIG. 6 shows a front view of a liquid separation assembly 402 having a liquid separation element 403 functionally similar to the liquid separation element 103 shown in FIGS. 3A-3C, and including an overflow port 107 constituted by a closed figure cutout 404 on the liquid separation element 403, for example an elliptically shaped cutout, and serves to allow the second liquid 17 to flow into the conduit 13 when the second liquid 17 inside the conduit access unit 18 reaches a predetermined overflow level. Alternatively, the overflow port 107 can be constituted by several closed figure cutouts, of a same shape or different shapes.

FIG. 7 shows a front view of a liquid separation assembly 502 having a liquid separation element 503 functionally similar to the liquid separation element 102 shown in FIGS. 3A-3C, and including an overflow port 107 constituted by a non-closed figure cutout 504 on the liquid separation element 503, for example a rectangular shaped cutout, formed on a top edge of the liquid separation element 503.

Controller Based Liquid Separation Systems

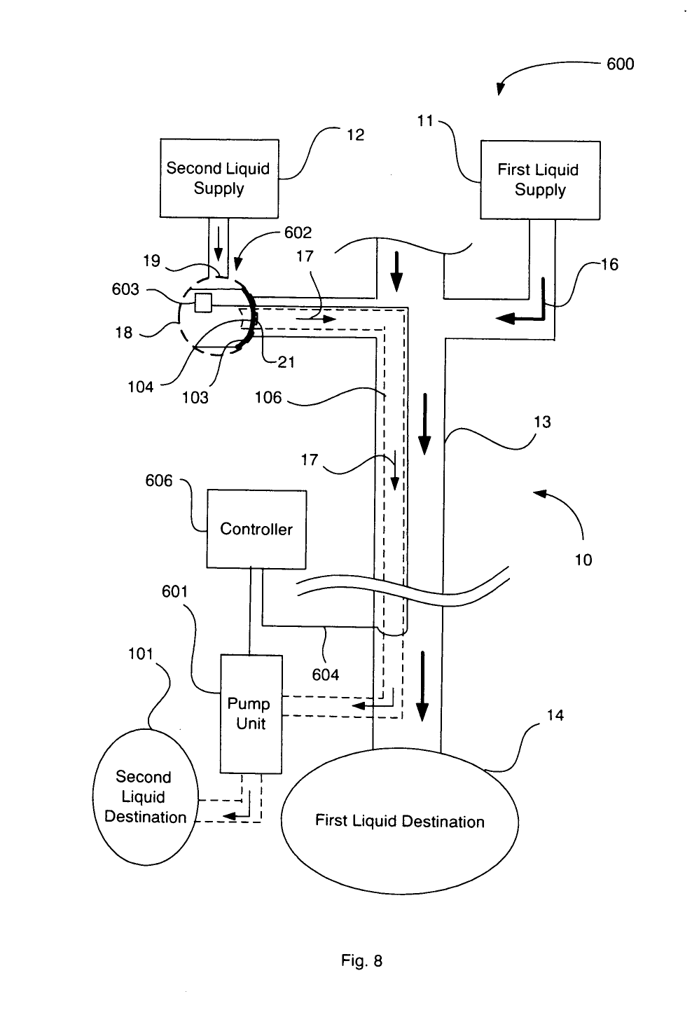

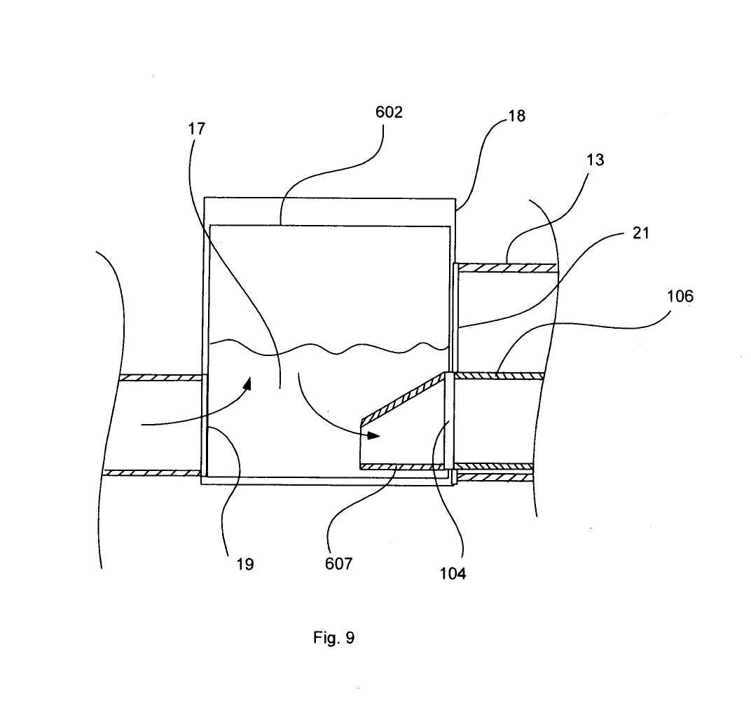

FIG. 8 shows an exemplary liquid separation system 600 installed in a liquid distribution installation 10. The liquid separation system 600 is similar to FIG. 2's liquid separation system 100 and differing in that the liquid separation system 600 is automatic and does not solely rely on gravity for having the second liquid 17 flow to the second liquid destination 101 as in the liquid separation system 100. Instead, the liquid separation system 600 uses a controller-controlled pump unit 601 for drawing the second liquid 17 from the conduit access unit 18 through the piping system 106 to the second liquid destination 101.

The liquid separation system 600 includes a liquid separation assembly 602 similar to FIG. 2's liquid separation assembly 102 including the liquid separation element 103 and the liquid separation port 104, differing from the latter in that the liquid separation assembly 602 includes a liquid level sensing mechanism 603. The liquid level sensing mechanism 603 is electrically connected through a signal link 604 to a controller 606 which controls the operation of the pump unit 601. The signal link 604 is a hard-wired link threaded with the piping system 106, although it may alternatively be a wireless link. The hard-wired link 604 may also be used to supply operating power to the liquid level sensing mechanism 603, although the operating power may additionally or alternatively be supplied by a battery or other type of voltage source proximally located to the liquid level sensing mechanism 603. The liquid level sensing mechanism 603 may include an active sensor for measuring a second liquid level inside the conduit access unit 18. Alternatively, the liquid level sensing mechanism 603 may include a passive sensor, for example a switch, which closes an electric circuit according to the second liquid level inside the conduit access unit 18. The liquid level sensing mechanism 603 senses when the second liquid 17 in the conduit access unit 18 reaches a predetermined maximum liquid level and sends an activation signal to the controller 606 which in response, activates the pump unit 601. The liquid level sensing mechanism 603 additionally senses when the second fluid 17 in the conduit access unit 18 reaches a predetermined minimum liquid level above the opening to the liquid separation port 104, and sends a deactivation signal to the controller 606 which responsively deactivates the pump unit 601. Additionally or alternatively to having the liquid level sensing mechanism 603 send the deactivation signal, the controller 606 may be programmed with a time-out period which upon expiration, the pump unit 601 is deactivated.

The liquid separation assembly 602 may be adapted with a port opening reducer 607 as shown in FIG. 9. The port opening reducer 607 attaches to the liquid separation port 104 from within the conduit access unit 18, for reducing a height of the opening of the liquid separation port 104. This allows setting the predetermined minimum liquid level inside the conduit access unit 18 to a lower level than when the port opening reducer 607 is not used. Use of the port opening reducer 607 is advantageous as the pump unit 601 may remain in operation for lower levels of second fluid 17 inside the conduit access unit 18 without risk of air flowing into the liquid separation port 104.

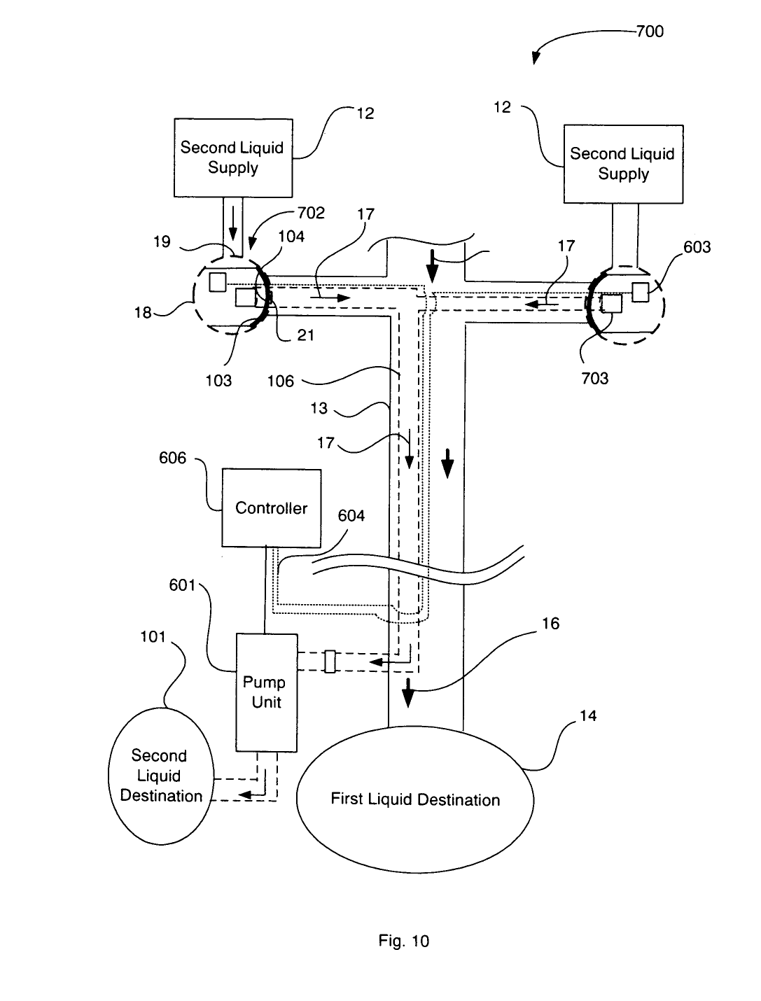

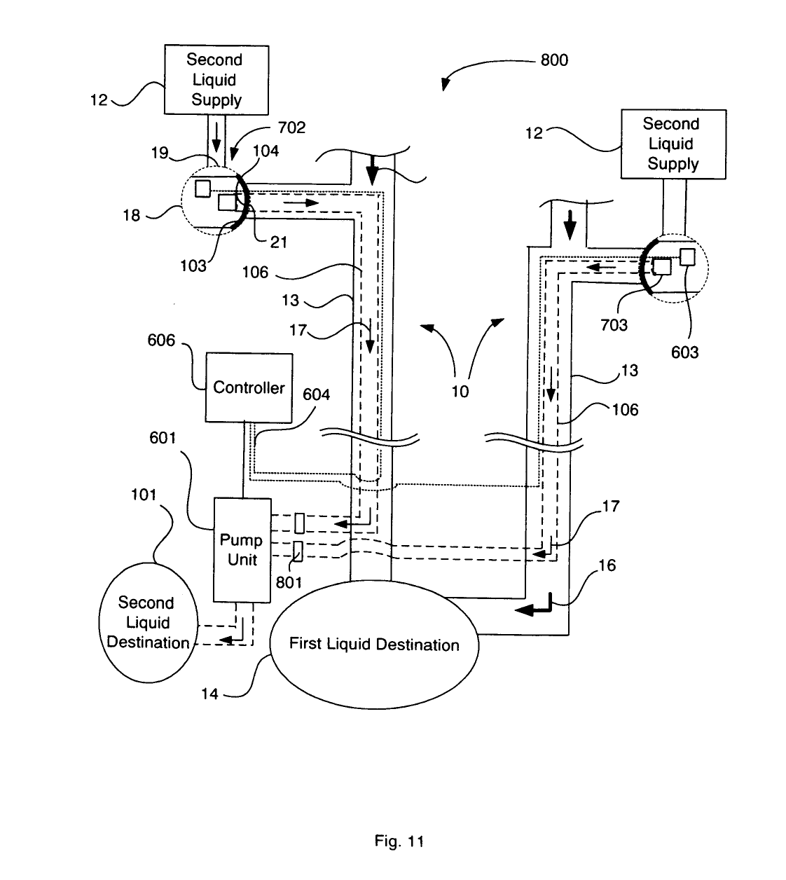

FIG. 10 shows an exemplary liquid separation system 700 installed in the existing liquid distribution installation 10 having two second liquid supplies 12 connecting through two conduit access units 18 to the conduit 13. The liquid separation system 700 is similar to the liquid separation system 600 shown in FIG. 8 differing in that the piping system 106 fluidly connects to the two conduit access units 18, and that a level of the second liquid 17 in each conduit access unit 18 is separately monitored by the controller 606 for activating or deactivating the pump unit 601.

The liquid separation system 700 includes in each conduit access unit 18 a liquid separation assembly 702 similar to the liquid separation assembly 602 in FIG. 8 including the liquid separation element 103, the liquid separation port 104, and the liquid level sensing mechanism 603, and differing from the latter in that the liquid separation assembly 702 includes a port blocking mechanism 703. The port blocking mechanism 703 is configured for maintaining the liquid separation port 104 blocked when the level of the second liquid 17 inside the conduit access unit 18 is below the predetermined minimum liquid level. This prevents air flowing through the liquid separation port 104 and through the piping system 106 into the operating pump unit 601. This condition may arise, for example, when second liquid 17 flows into only one of the conduit access units 18 and there is none, or insufficient, flow into the other conduit access unit 18.

The port blocking mechanism 703 may include a flotation mechanism having a float which moves up and down as the level of the second liquid 17 rises and falls inside the conduit access unit 18, and includes a sealing element which seals the liquid separation port 104 or the opening reducer 607 when the float falls below the minimum liquid level. Alternatively, the port blocking mechanism 703 may include an electromechanical mechanism having a controller-operated valve which closes the liquid separation port 104 responsive to the controller 606 receiving the deactivation signal, and opens the valve upon receiving the activation signal.

The port blocking mechanism 703 may form part of the liquid level sensing mechanism 603 in the liquid separation assembly 702. For example, the float in the flotation mechanism may be used for triggering a first switch (not shown) when the second liquid 17 reaches the maximum liquid level, sending the activation signal to the controller 606, and/or for triggering a second switch (not shown) when the second liquid 17 decreases to the minimum liquid level sending the deactivation signal to the controller 606.

In the liquid separation system 700, the controller 606 is programmed to activate the pump 601 responsive to receiving only one activation signal from any one of the liquid level sensing mechanisms 603. Additionally, the controller 606 is programmed to deactivate the pump 601 responsive to receiving a deactivation signal from all the liquid level sensing mechanisms. Each liquid level sensing mechanism 603 connects to the controller 606 through a dedicated signal link 604.

FIG. 11 shows an exemplary liquid separation system 800 installed in a network of two existing liquid distribution installations 10 of FIG. 1 sharing a same first liquid destination 14. The liquid separation system 800 is similar to the liquid separation system 600 shown in FIG. 8, differing from the latter in that the second liquid supply 12 in each existing liquid distribution installation 10 connects through its own piping system 106 to the same second liquid destination 101. Similarly to liquid separation system 600, the controller 606 activates the pump unit 601 responsive to receiving the activation signal from any one of the liquid level sensing mechanisms 603, and deactivates the pump unit 601 responsive to receiving the deactivation signal from all the liquid level sensing mechanisms 603.

In addition, or as an alternative, to the port blocking mechanism 703, controller-operated valves 801 may fluidly disconnect any one of the piping systems 106 from the pump unit 601 responsive to the controller 606 receiving the deactivation signal from any one of the liquid level sensing mechanisms 603 associated with the piping system 106 to be disconnected, and may fluidly reconnect the disconnected piping system 106 upon receiving the activation signal. Additionally, the controller-operated valves 801 may be used for selectively disconnecting any one of the piping systems 106 for performing repairs or other types of maintenance on any part of the system 800 and/or on any existing liquid distribution installation 10.

Method for Installing a Liquid Distribution Installation

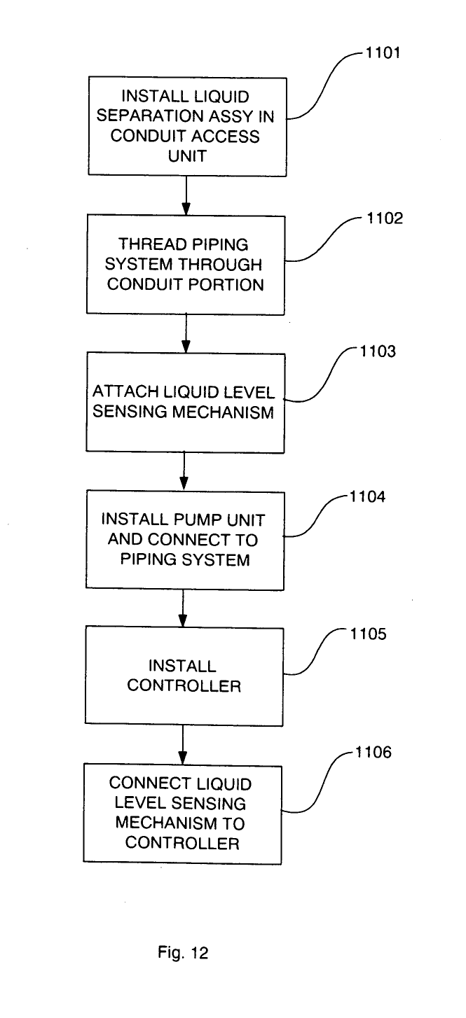

FIG. 12 shows a flow diagram of a method for installing a liquid distribution installation 10 with the disclosed liquid separation systems. For installing a gravity-based system, only steps 1101 and 1102 are practiced. For installing an automatic system, all steps 1101-1106 are practiced.

In step 1101, the piping system is threaded through at least a portion of the conduit and fluidly connected to the liquid separation assembly.

In step 1102, the liquid separation assembly is installed in the conduit access unit.

In step 1103, the liquid level sensing mechanism is attached to the liquid

In step 1104, the pump unit is installed and is connected to the piping system.

In step 1105, the controller is installed and connected to the pump unit.

In step 1106, the liquid level sensing mechanism is connected to the controller. The sensing link may be laid out at this time or, alternatively, in any of the previous steps from step 1101 onwards.

Kits for Installing Liquid Separation Systems

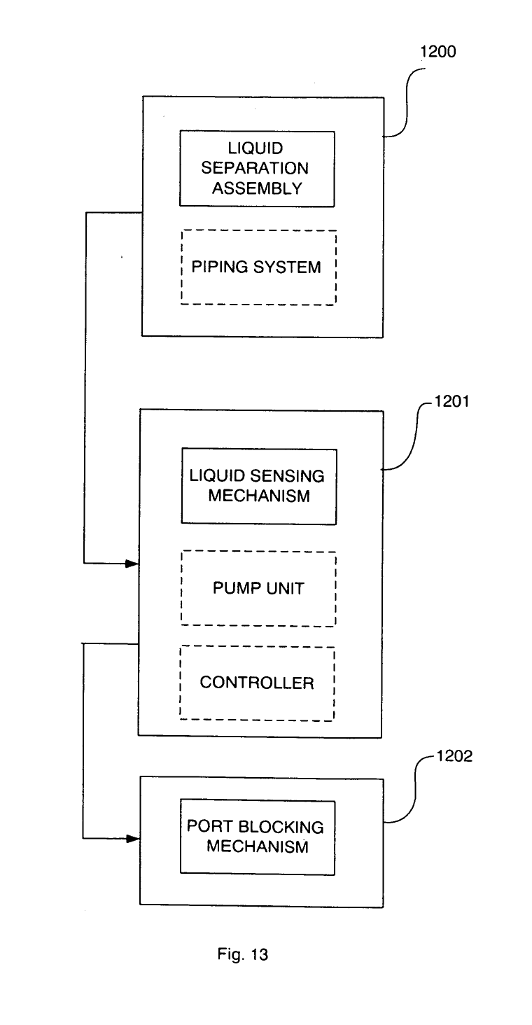

FIG. 13 shows a kit 1200 for installing a gravity-based liquid separation system. The kit 1200 contains a liquid separation assembly, and may include a piping system (shown in hatched lines) as an optional, supplemental component. The kit 1200 can be expanded for installing an automatic liquid separation system by adding a supplemental automatic kit 1201 having a liquid sensing mechanism. The supplemental automatic kit 1201 may include a controller and/or a pump unit as optional, supplemental components. The kit 1200 can be further expanded for retrofitting a liquid distribution installation 10 having multiple second supplies and conduit access units for automatic liquid separation by adding to the kit 1200 and the supplemental automatic kit 1201 a supplemental port blocking kit 1202 which includes a port blocking mechanism to be installed in each conduit access unit for preventing air from reaching a pump unit during operation.

While the invention has been described with respect to a limited number of embodiments, it will be appreciated that many variations, modifications, and other applications of the invention can be made within the scope of the appended claims.

1. A liquid separation system for installing in a liquid distribution installation having a conduit with a first liquid destination, a first liquid supply for supplying a first liquid into the conduit, and a second liquid supply for supplying a second liquid into the conduit via a conduit access unit with an inlet and an outlet in flow communication with the conduit, the liquid separation system comprising:
a) a liquid separation assembly for installation in the conduit access unit, said liquid separation assembly including a liquid separation element for covering the outlet for preventing second liquid flowing into the outlet and a liquid separation port; and
b) a piping system connected to said liquid separation port and threaded through at least a section of the conduit for re-directing second liquid flowing into the conduit access unit to a second liquid destination different from the first liquid destination.

2. A system according to claim 1 wherein on installation of said liquid separation assembly in the conduit access unit, said liquid separation element includes an overflow port above said liquid separation port such that in the event of second liquid in the conduit access unit reaching a predetermined overflow level, the second liquid flows through said overflow port along the conduit to the first liquid destination.

3. A system according to claim 2 wherein said overflow port is constituted by a non-closed figure overflow cutout.

4. A system according to claim 2 wherein said overflow port is constituted by a closed figure overflow cutout.

5. A system according to claim 1 wherein said liquid separation assembly further includes a liquid level sensing mechanism for sensing the level of second liquid in the conduit access unit and providing at least one sensing signal, and the system further comprising:
(c) a pump unit for selectively drawing second liquid from the conduit access unit through said piping system; and
(d) a controller for controlling said pump unit in response to said at least one sensing signal.

6. A system according to claim 5 wherein said at least one sensing signal is indicative of a minimum level of second liquid in the conduit access unit.

7. A system according to claim 1 wherein said at least one sensing signal is indicative of a maximum level of second liquid in the conduit access unit.

8. A system according to claim 1 wherein said liquid separation assembly further includes a port blocking mechanism for selectively blocking said liquid separation port for preventing air from being drawn into said piping system by the operation of said pump unit when the level of the second liquid in said conduit access unit is below a predetermined minimum level.

9. A system according to claim 8 wherein said port blocking mechanism is constituted by a flotation blocking mechanism including a sealing element for blocking said liquid separation port.

10. A system according to claim 8 wherein said port blocking mechanism is constituted by an electromagnetic blocking mechanism including a valve for blocking said liquid separation port.

11. A liquid separation element for use in a liquid separation system according to claim 1.

12. A liquid separation assembly for use in a liquid separation system according to claim 1.

13. A kit for installing a liquid separation system according to claim 1 in a liquid distribution installation.

14. A method of installing a liquid separation system according to claim 1 in a liquid distribution installation, the method comprising the steps of:
a) installing a liquid separation assembly in a conduit access unit, said liquid separation assembly including a liquid separation element having a liquid separation port; and
b) threading a piping system through at least a section of the conduit and attaching said piping system to said liquid separation port for enabling second liquid flowing into the conduit access unit to flow to the second liquid destination.

15. A method according to claim 14 further comprising the steps of:
c) attaching a liquid level sensing mechanism to said liquid separation assembly for sensing the level of second liquid in the conduit access unit and providing at least one sensing signal; and
d) installing a pump unit and connecting said piping system to said pump unit for selectively drawing second liquid from the conduit access unit through said piping system;
e) installing a controller for controlling said pump unit; and
f) operationally connecting said liquid level sensing mechanism to said controller for controlling said pump unit in response to said at least one sensing signal.
